(19) United States
(12) Patent Application Publication
(10) Pub. No.: US 2004/0112302 A1
(43) Pub. Date: Jun. 17, 2004

(54) Child restraint device and method of use

(76) Inventor: John M. Guynn, Salt Lake City, UT (US)

Correspondence Address: John M. Guynn, WORKMAN NYDEGGER, 1000 Eagle Gate Tower, 60 East South Temple, Salt Lake City, UT, 84111, US

(21) Appl. No.: 10/729,000

(22) Filed: Dec. 5, 2003

Related U.S. Application Data
(60) Provisional application No. 60/431,443, filed on Dec. 6, 2002.
(60) Provisional application No. 60/435,535, filed on Dec. 20, 2002.

(51) Int. Cl. B60R 22/12

(52) U.S. Cl. 119/770

(57) ABSTRACT

A child restraint device comprises at least one handle attachable to a desired location next to an infant's or child's body. The handle permits a parent or other person to hold or restrain a child in a more secure and reliable manner, such as while giving the child a bath, compared to simply grabbing a child's hand, arm or other body part. The handle is advantageously located nearer the child's center of gravity compared to a child's arm or leg. For example, the handle may advantageously be located next to or near the child's spine, or it may be located in the middle of the child's chest or stomach area (e.g., at or near the sternum). One or more handles may be located under the child's arm pits. The handle typically has increased friction compared to a child's skin, particularly when contacted with soapy water, so as to improve the reliability of the grip.

### CROSS-REFERENCE TO RELATED APPLICATIONS

This application claims the benefit under 35 U.S.C. § 119 of U.S. provisional application Serial No. 60/431,443, filed Dec. 6, 2002 and U.S. provisional application Serial No. 60/435,535, filed Dec. 20, 2002. The foregoing provisional applications are incorporated herein in their entirety.

### BACKGROUND OF THE INVENTION

1. The Field of the Invention

The invention is in the field of infant or child restraint devices, more particularly restraint devices suitable for holding, supporting or restraining an infant or young child in a desired position, such as while bathing, carrying or lifting the child.

2. The Relevant Technology

Bathing an infant or young child can be an enjoyable experience. Baths can be fun for the child and provide a nurturing setting where parent/child bonding can occur. Unfortunately, the bathing experience can be marred if the young child or infant slips out of the parent's hand and hits the bathtub, thus potentially injuring or traumatizing the child.

Even if the child or infant is successfully held without fall or injury, the bathing experience can be stressful whenever constant vigilance is required to properly hold and keep the child from falling. The bathing experience can be nerve-wracking because of the constant fear that the infant or young child might slip out of the parent's hand(s) and fall against the bathtub wall, or be submerged and drown.

The child's anatomy and lack of physical development contribute to the difficulty. The soft, smooth skin of a baby can create a perilous situation during bath time. When a baby's skin becomes wet with water, particularly soapy water (especially when soft water is used), it becomes slick and difficult to grasp in a safe and secure manner. To prevent the child from slipping or falling, a nervous or inexperienced parent may reflexively grip a baby's arm or leg more firmly, thus potentially hurting the child.

In addition, infants are generally unable to balance themselves well within a bathtub. Children can generally only sit up on their own after reaching an age of between about 5-7 months. Even if a baby can sit upright on a dry surface, it is more difficult for the baby to reliably and safely sit upright on a wet, slippery bath tub surface slick with soapy water. As illustrated in FIGS. 1 and 2, the parent is often required to physically hold a baby 10 in a sitting (FIG. 1) or standing (FIG. 2) position within the bathtub 12 during the entire bathing process.

Propping up a baby by grasping one hand, while using the free hand to wash, can be quite challenging. Apart from the baby's limbs, there is virtually no part of a baby's body that is safe to grasp with only one hand without injuring the baby. Because a baby's arm extends laterally from the baby's body, gripping the baby's arm causes the baby to be gripped away from its center of gravity, (i.e., the torso). This unbalanced relationship can result in the baby leaning away from the point of contact, resulting in a potentially serious fall if the grip is broken.

The unbalanced relationship between gripped arm and torso is exacerbated by the loose connection between the baby's arm and shoulder. The shoulder joint and elbow of a baby have many degrees of freedom and can constantly bend or rotate through different conformations depending on the mechanical and gravitational relationship between the baby's arm and body. Moreover, babies often resist having their arms grabbed, and a baby may jerk its arm, possibly causing the grip to fail.

The safest way to hold a wet, soapy baby within a bathtub is to hold it with both hands around the baby's torso. This allows the baby to have full use of its hands and arms. Alternatively, the parent may grasp both arms of the baby simultaneously. Unfortunately, using both hands leaves no hand free to wash the baby. As a result, washing a young baby often requires two parents: one to hold and one to wash.

There are also other contexts in which a child must be carried, supported, lifted or otherwise restrained in which grabbing the child by one or both arms, or some other part of the child's body, is unsafe, difficult or otherwise undesirable.

In view of the foregoing, it would be an advancement in the art to provide a restraint device that can be attached to a baby or child's body and that would allow a person to safely and reliably hold the baby or child in a desired position.

### SUMMARY OF THE INVENTION

The invention relates to a child restraint device that can be attached to an infant or child so as to provide a way to hold or grip the infant or child in a desired position in a secure and safe manner. The restraint device includes one or more handles that can be positioned in a desired location and then grasped instead of, or in addition to, one or more of the child's limbs in order to more securely prop up or hold the child in a desired position.

In one embodiment, the restraint device is useful while bathing an infant or young child. The handle may advantageously be designed to provide increased friction compared to a child's skin when immersed in or otherwise wetted by slippery, soapy water.

The handle of the restraint device may be attached in any desired location, though preferably so as to be near the baby's center of gravity. For example, the handle can be located in the middle of a baby's back or shoulder area and/or in the middle of the infant's stomach or chest area (e.g., near the child's spine and/or sternum). Where the restraint device includes two handles, each handle may advantageously be located on an opposite side of the child's body (e.g., on the front and back, or on the left and right sides, of the child's body).

The handle of the restraint device may be attached to the baby's body in any desired manner, such as by means of a corset or harness comprising one or more of a sheet, strap, or fastening device. In one embodiment, the handle may be attached by wrapping a corset or harness at least partially around the child's torso and then fastening it by means of one or more fastening devices known in the art (e.g., snaps, a hook and loop system, belt buckles, latches, ties, ratchet buckle devices, and the like). Alternatively, the handle may be attached to the child by straps that wrap around other portions of the baby's body, such as around the top of the shoulder and under the baby's armpits and/or around the baby's crotch area. The handle may be attached in any manner as may be developed through routine testing following the principles disclosed herein. The handle should be attached to the child in a manner that does not result in strangulation, inadvertent slippage or falling, or other serious injury to the child.

The handle may comprise any desired material or fabric, as may the straps, corset, harness or other attachment means for attaching the handle to the child's body. For example, the handle may comprise a flexible woven or knitted fabric. The handle may comprise, at least in part, a more rigid material, such as molded plastic, shaped metal or a ceramic. It may comprise an elastomer, polymer, or composite material.

The straps, corset, harness or other attachment means for attaching the handle to the child may advantageously comprise one or more of a fabric, mesh, plastic, elastomer, polymer or composite material that is relatively soft and flexible so as to be comfortable when attached to and worn by the child. Surfaces of the restraint device that directly contact the baby's skin may be optionally lined with a soft lining material, such as fleece, felt, gel, elastomeric foam, and the like.

The restraint devices may optionally comprise one or more features that provide additional functionality or versatility as desired. For example, a restraint device may be designed with a head restraining system that is able to prop up or hold an infant's head in a desired position relative to the infant's body. This feature may be advantageous when the restraint device is used with an infant that lacks sufficient neck strength to hold his or her head up while in a sitting, standing or reclining position so as to prevent injury or discomfort to the infant's neck when the restraint device is in use. The head restraining system may, for example, comprise a hood that can engage at least a portion of the infant's head so as to restrain movement of the head. The head restraining means may additionally or alternatively comprise a chin guard, optionally in combination with a head strap.

The restraint device may include one or more attachment features that permit it to be used in conjunction with other devices (“auxiliary devices”), e.g., that permit a restraint device to be releasably connected to a car seat, carriage, stroller, high chair, walker, sitting device, standing device, leash, and the like. Auxiliary devices may be provided together with the restraint device in the form of a kit. In this way, the restraint device can be used to safely and reliably restrain an infant or child in a variety of circumstances in addition to bathing a child. Integral features of the restraint device can be modified or used as is in conjunction with other devices.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 illustrates a typical bath situation in which a child is being held in a sitting position;

FIG. 2 illustrates a typical bath situation in which a child is being held in a standing position;

FIG. 3 depicts a child that is more securely held in a standing position by means of a child restraint device according to the invention;

FIG. 4 depicts a child that is more securely held in a sitting position by means of a child restraint device according to the invention;

FIG. 5 depicts an exemplary child restraint device according to the invention that includes a pair of straps comprising a corset or harness that is able to be releasably wrapped around the torso of a child, and a handle attached thereto;

FIGS. 6A and 6B depict exemplary child restraint devices according to the invention that comprise a corset or harness that includes a sheet and a pair of straps extending from opposite ends of the sheet that together are able to be releasably wrapped around the torso of the child's body, a first handle attached to the sheet, and a second handle attached to two of the straps;

FIG. 7A depicts an exemplary child restraint device according to the invention comprising a corset or harness that includes a single sheet or strap that is able to be releasably wrapped around the torso of a child's body, and a handle attached thereto;

FIG. 7B depicts a child restraint device according to the invention similar to the one depicted in FIG. 7A, except that it further includes a second handle comprising a releasable buckle;

FIGS. 8A-8E depict exemplary fastening means that may be used to releasably attach a child restraint device according to the invention to a portion of a child's body;

FIG. 9 depicts an exemplary child restraint device according to the invention comprising a handle attached to a plurality of straps that wrap around a child's shoulders and crotch area;

FIG. 10 depicts an exemplary child restraint device according to the invention that comprises a handle attached to a harness or corset comprising a plurality of laterally spaced-apart straps that are sized so as to wrap around at least a portion of a child's torso;

FIG. 11 illustrates an exemplary child restraint device according to the invention wrapped around a child's torso with attachment means attached to the front of the child's body and a handle positioned next to the child's back;

FIG. 12 depicts an exemplary child restraint device according to the invention that includes a head restraint system comprising a hood and straps that interconnect the hood with the corset or harness portion;

FIG. 13 depicts an exemplary child restraint device according to the invention that includes a head restraint system comprising a chin guard and a strap that wraps around the child's head;

FIGS. 14A and 14B depict an exemplary child restraint device according to the invention comprising a corset or harness that includes a single sheet or strap that is able to be releasably wrapped around the torso of a child's body, and a pair of handles attached to the sheet or strap;

FIGS. 15A and 15B depict an exemplary child restraint device according to the invention comprising a corset or harness that includes a single sheet or strap that is able to be releasably wrapped around the torso of a child's body, a handle attached near the middle of the sheet or strap, and a releasable strap attached near an end of the sheet or strap that can be selectively formed into a second handle;

FIGS. 16A-15C depict an exemplary child restraint device according to the invention comprising a corset or harness that includes a single sheet or strap that is able to be releasably wrapped around the torso of a child's body, a handle attached near the middle of the sheet or strap, and a releasable strap attached near an end of the sheet or strap that can either be selectively formed into a handle or used to attach the restraint device to another device or object;

FIGS. 17A-17B depict an exemplary child restraint device according to the invention attached to child and that includes features that allow the restraint device to be releasably attached to another device or object such as a stationary object or a leash; and

FIGS. 18A and 18B show a child being lifted off the ground using a child restraint device according to the invention.

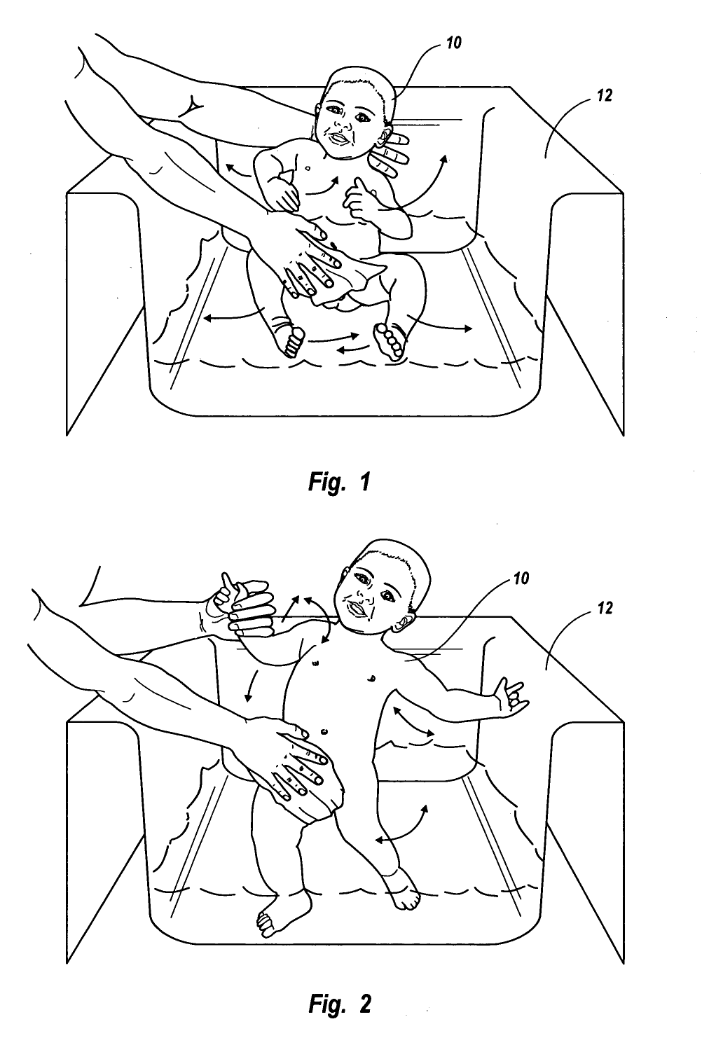

### DETAILED DESCRIPTION OF THE PREFERRED EMBODIMENTS

The present invention is directed to a child restraint device that includes at least one handle that can be attached to an infant or child in a desired location so as to provide a way to securely and reliably support or hold an infant or child in a desired position. The child restraint device according to the invention can be used to hold or restrain a child or infant for any desired reason. The present invention effectively provides an auxiliary handle that is located closer to the child's center of gravity, and that is generally easier to grip, compared to a child's limb. The handle may advantageously be fabricated so as to have increased friction compared to a baby's skin when contacted with soapy water. Because the handle is not part of the baby's body, it may be gripped as firmly as needed.

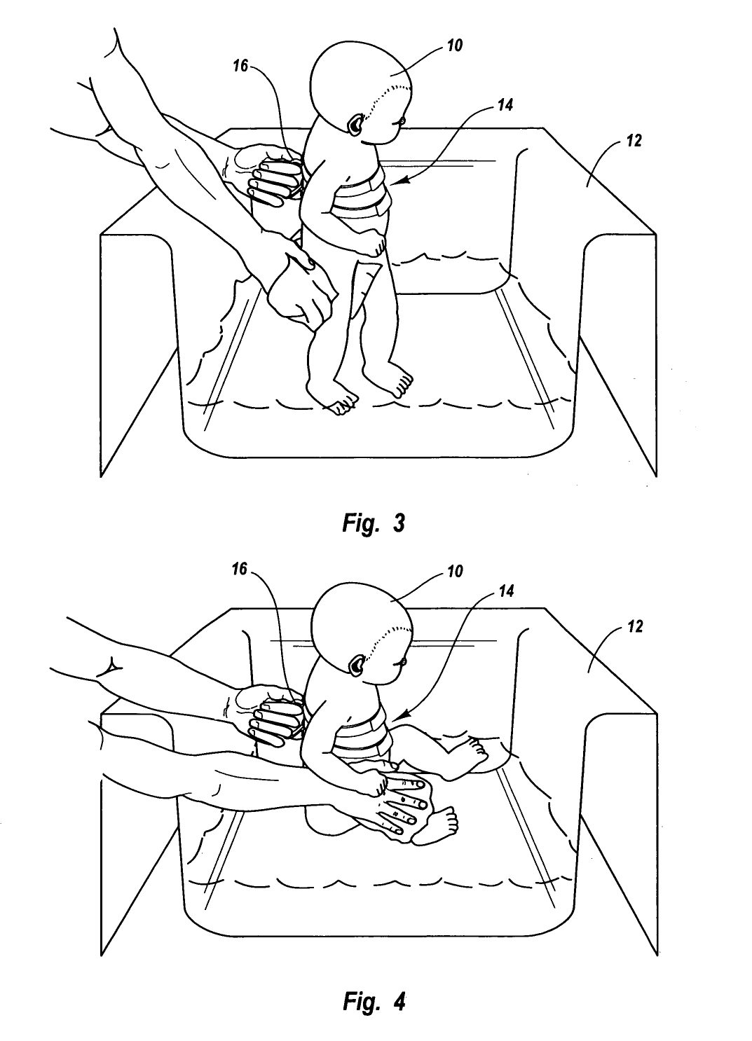

Reference is now made to FIGS. 3-18, which illustrate exemplary child restraint devices according to the invention and suggest exemplary methods of use. FIGS. 3 and 4 depict a young child 10 standing or sitting in a bathtub 12. A restraint device 14 comprising a handle 16 is attached to child 10. FIG. 3 shows a person safely holding child 10 in a standing position by gripping handle 16 with a single hand. The other hand is then free to, e.g., wash, comfort or further steady the child 10. FIG. 4 shows a person safely holding child 10 in a sitting position by gripping handle 16 with a single hand, thus freeing the other hand.

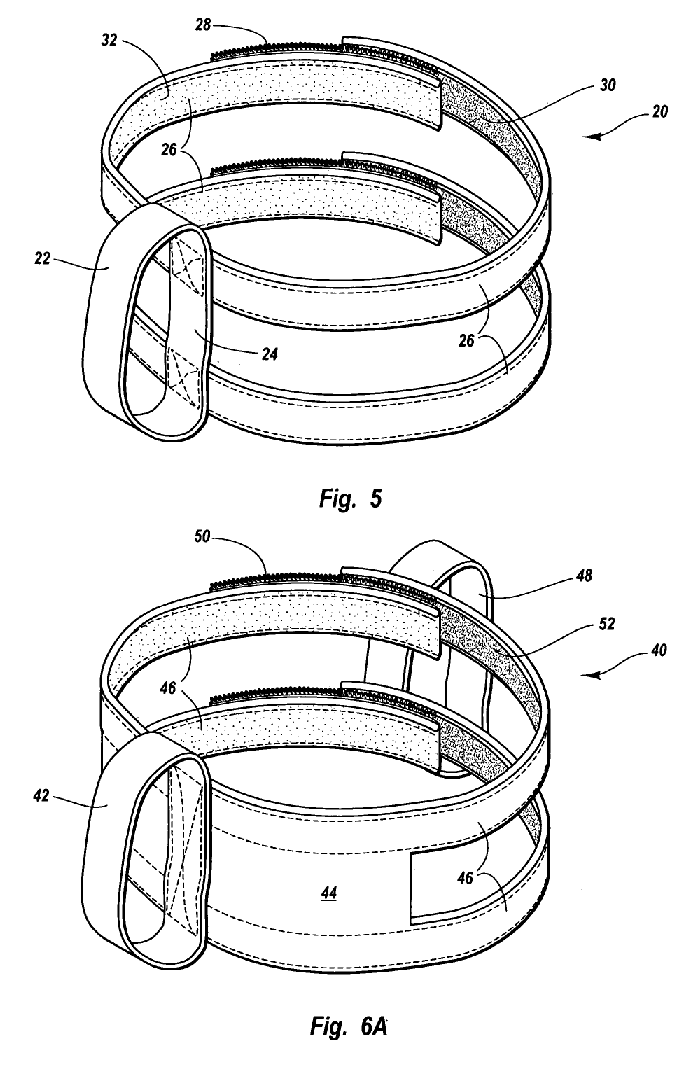

FIG. 5 depicts an embodiment of a restraint device 20 that includes a handle 22 attached to a corset or harness composed of a center strip portion 24 and a pair of laterally spaced-apart flexible straps 26. Straps 26 are sized and configured so as to wrap at least partially around a torso of a child. In some embodiments, straps 26 may overlap when wrapped around the torso of a child so that one end of a strap 26 can be releasably attached to another end of the strap 26.

Restraint device 20 advantageously includes one or more fastening devices that allow restraint device 20 to be releasably attached to a baby or child's body. For example, as shown in FIG. 5, at least a portion of straps 26 may be covered with corresponding components of a hook and loop system, such as a region of hooks 28 attached to one surface of straps 26 (e.g., facing away from the baby's body) and a region of loops 30 attached to an opposite surface of straps 26 (e.g., facing toward the baby's body). In this way, the region of hooks 28 on one side of each strap is able to engage the region of loops 30 on the other side of strap 26 when restraint device 20 is wrapped around a child's body. The hooks 28 and loops 30 of the hook and loop system depicted in FIG. 5 comprise an example of a fastening device, or fastening means for releasably attaching a restraint device to a child's body.

The overlapping nature of straps 26, together with the size and positioning of the hooks 28 and loops 30, allows straps 26 to overlap and be locked in place in a variety of positions to account for differences in torso size among children. In this way, a single restraint device 20 can be adjusted so as to accommodate and be attached to children of varying size, shape and/or age.

Exemplary restraint device 20 may further include a cushioning material 32 on inner surface of straps 26 in order to increase comfort when restraint device 20 is worn by a child. Cushioning material 32 may comprise any known material, such as fleece, felt or other soft and flexible fabrics, silicone or other polymeric gel material, or polyurethane foam or other soft and flexible foam material. At least a portion of the restraint device that comes in contact with a child's body may include a friction-enhancing material, such as neoprene or other elastomeric material, in order to decrease the tendency of the restraint device to move in an unwanted fashion relative to the child's body when in use.

When restraint device 20 is in use, handle 22 may advantageously be positioned at or near a “central balancing plane” of a child's torso. In general, each child has a central balancing plane that passes through the spine and/or sternum in a manner that essentially bisects the child's body into two halves that are approximate mirror images of each other. Positioning the handle 22 of a restraint device 20 anywhere along or near the central balancing plane provides for maximum balance and control of a child when the restraint device is in use.

For example, positioning the handle 22 next to any portion of a child's spine along the child's back provides good balance and control (see FIGS. 3 and 4). Similarly, positioning the handle anywhere along the central balancing plane on the front of the child's body, such as in the chest, sternum or stomach areas, also provides good balance and control. Alternatively, the handle 22 may be positioned adjacent to a child's side (e.g., beneath the arm pit). Of course, it is not necessary for the handle to be exactly aligned with the central balancing plane, although it is preferable for it to be at or near the central balancing plane.

In general, the center of the restraint device handle is preferably located within three inches on either side of the central balancing plane of the child when in use, more preferably within about two inches on either side of the balancing plane, and most preferably within about one inch on either side of the balancing plane.

As depicted in FIG. 5, handle 22 of restraint device 20 may be positioned so as to be substantially vertically aligned (i.e., substantially parallel to the child's spine) when a child is in a sitting or standing position. It should be understood, however, that the handle 22 may be oriented relative to the child's body in any desired angle, such as perpendicular to the child's spine, sternum or central balancing plane, or any angle between perpendicular and parallel as desired to provide a desired gripping angle.

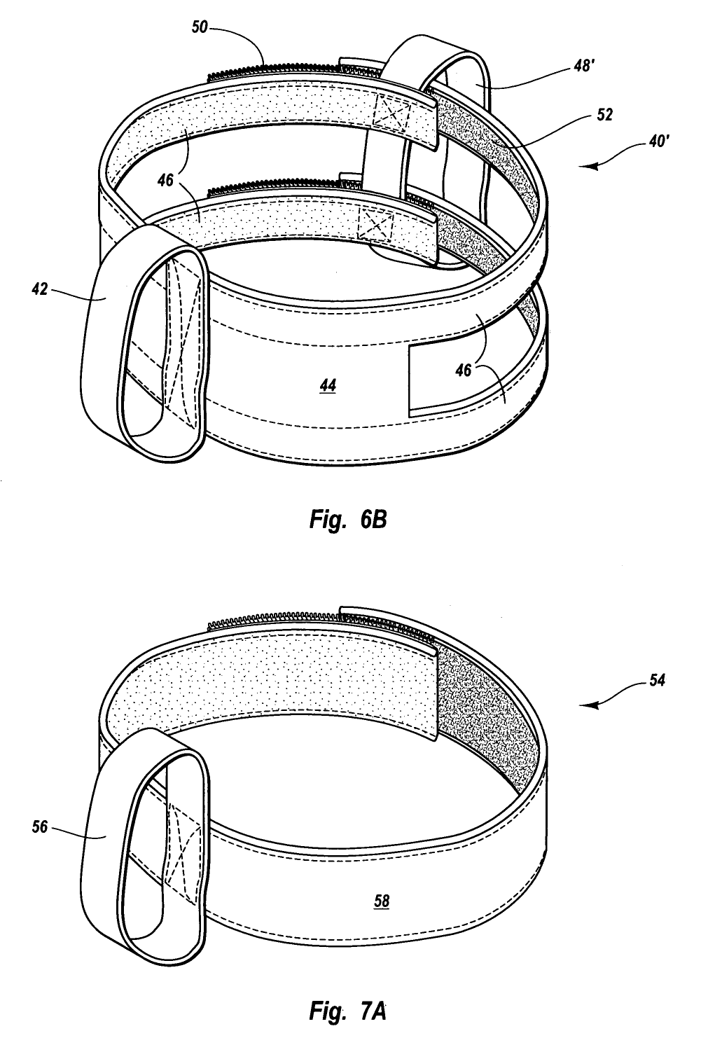

FIGS. 6A and 6B illustrate exemplary child restraint devices that include two opposing handles. FIG. 6A depicts a restraint device 40 that includes a handle 42 attached to a sheet portion 44. A pair of end straps 46 extend from each end of sheet portion 44. Sheet portion 44 and end straps 46 together comprise a corset or harness used to attach handle 42 to a child. Sheet portion 44 and end straps 46 are sized and configured so that together they can wrap around a child's body in a manner so that at least a portion of end straps 46 extending from one side of sheet portion 44 overlap at least a portion of end straps 46 extending from the other side of sheet portion 44. This is particularly advantageous in the case where a hook and loop system is used to attach opposing straps 46 together. FIG. 6A depicts a region of hooks 50 and a corresponding region of loops 52 that can be used to releasably attach opposing straps 46 together. Of course, it is within the scope of the invention to use alternative fastening means that do not require straps 46 to overlap.

The child restraint device 40 of FIG. 6A further includes an auxiliary handle 48 located opposite to handle 42 when restraint device 40 is in use. This embodiment provides separate handles on opposite sides of a child's torso body in order to provide added versatility. For example, a child may be alternatively held by a handle adjacent to the child's back or by a handle adjacent to the child's chest, sternum or stomach area without having to remove or reposition restraint device 40 relative to the child's body. The two handles 42, 48 may be gripped simultaneously so as to, e.g., facilitate safely lifting a child into or out of a bathtub.

FIG. 6B depicts a child restraint device 40′ that is similar to restraint device 40 of FIG. 6A, except that auxiliary handle 48′ is attached to the straps 46 located closest to the child's body when in use. In this way, gripping auxiliary handle 48′ is less likely to cause separation of the overlapped straps 46 in the case where the straps 46 are held together using a hook and loop system (e.g., VELCRO).

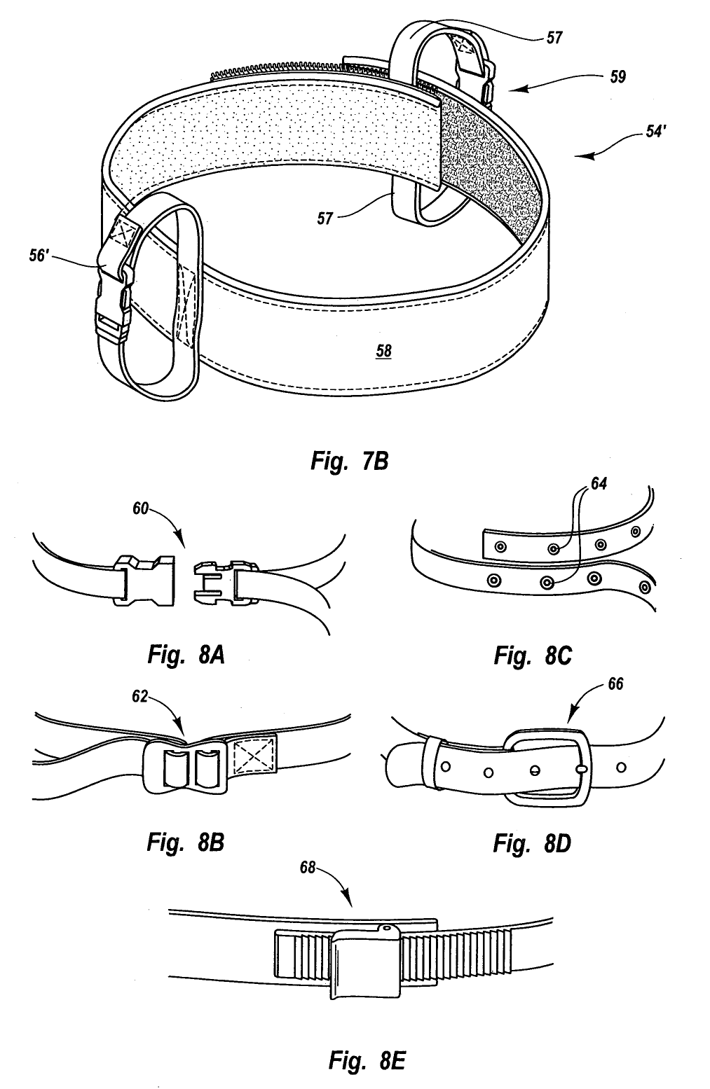

FIG. 7A depicts an exemplary restraint device 54 that includes a handle 56 attached to a single strap or sheet 58 sized and configured to wrap at least partially around a child's body. Depending on the type of fastening means used to releasably attach the strap or sheet 58 to a child's body, the strap or sheet 58 may or may not actually overlap when in use.

FIG. 7B depicts a modified restraint device 54′ similar to restraint device 54 of FIG. 7A, except that restraint device 54′ further includes a pair of cooperating straps 57 that are attached to and extend from the strap or sheet 58. Attached to cooperating straps 57 is a buckle system 59 that allows cooperating straps 57 to be selectively connected and unconnected as desired. In this way, an auxiliary handle can be formed using cooperating straps 57. The buckle system 59 optionally allows the cooperating straps 57 to be attached to a leash or auxiliary device (not shown) to provide additional versatility and functionality of restraint device 54′. Restraint device 54′ may include a non-releasable handle 56, as shown in FIG. 7A, or it may include a releasable handle 56′ as shown in FIG. 7B. Releasable handle 56′ provides additional versatility and functionality compared to non-releasable handle 56.

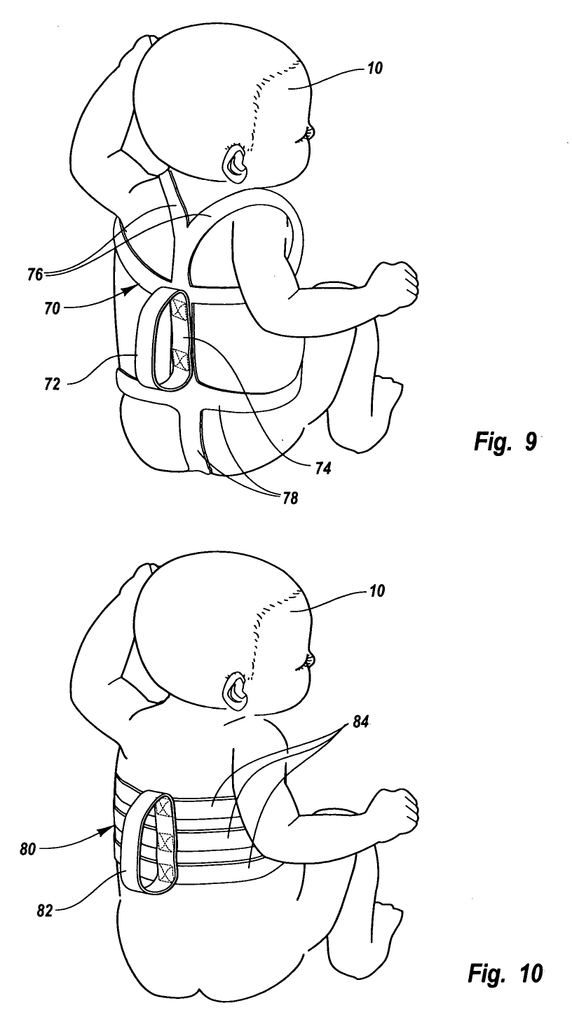

FIG. 8A depicts an exemplary fastening device or fastening means comprising an interlocking clasp 60 that includes a female receptacle and a male insertion device that engage each other in a snap-fit relationship. The working length of a handle or child restraint device can be increased or decreased by moving a belt or strap relative to the male insertion device and/or the female receptacle.

FIG. 8B depicts an exemplary slip/friction buckle system 62 that includes a flexible belt that wraps through corresponding slots within a buckle device. The working length of a handle or child restraint device can be adjusted by moving a belt or strap relative to the buckle device.

FIG. 8C depicts corresponding snaps that may be snapped together in order to releasably connect opposing ends of a handle or restraint device. A plurality of snaps may be provided in order to give the handle or restraint device an desired number of adjustment positions.

FIG. 8D depicts a belt and buckle system 66 that includes a flexible belt or strap having a series of holes therein, and a buckle that includes a pivoting rod that fits within and engages a selected one of the belt holes. The working length of a handle or restraint device can be adjusted depending on which hole engages the pivoting rod.

FIG. 8E depicts a notched belt and ratchet system 68 that includes a belt or strap having a series of notches or other protrusions and a ratchet clasp that engages the notches or protrusions. The notched belt or strap can be easily inserted into and moved relative to the ratchet clasp so as to quickly alter the working length of a handle or restraint device.

FIG. 9 depicts an exemplary restraint device 70 that includes a handle 72 attached to a center strap 74. A plurality of shoulder straps 76 are attached at an upper end of the center strap 74 and a plurality of crotch straps 78 are attached at a lower end of center strap 74. As in other embodiments, handle 72 is advantageously positioned within or along restraint device 70 so as to be located at or near a central balancing plane of a child 10 when in use.

FIG. 10 depicts an exemplary restraint device 80 that includes a handle 82 attached to a plurality of laterally spaced-apart attachment straps 84 that extend (e.g., perpendicularly) from either side of the handle 82 so as to wrap around the body of a child 10 when in use. Restraint device 80 includes three laterally spaced-apart attachment straps 84 that comprise a corset or harness used to attach handle 82 to the child 10. It should be understood, however, that restraint devices according to the invention may include any number of laterally spaced-apart attachment straps 84 that wrap around a child's body (e.g., two to five straps), or they may only include a single strap or sheet (e.g., FIGS. 7A and 7B). Attachment straps 84 may have any desired spacing, or they may have little or no spacing between them.

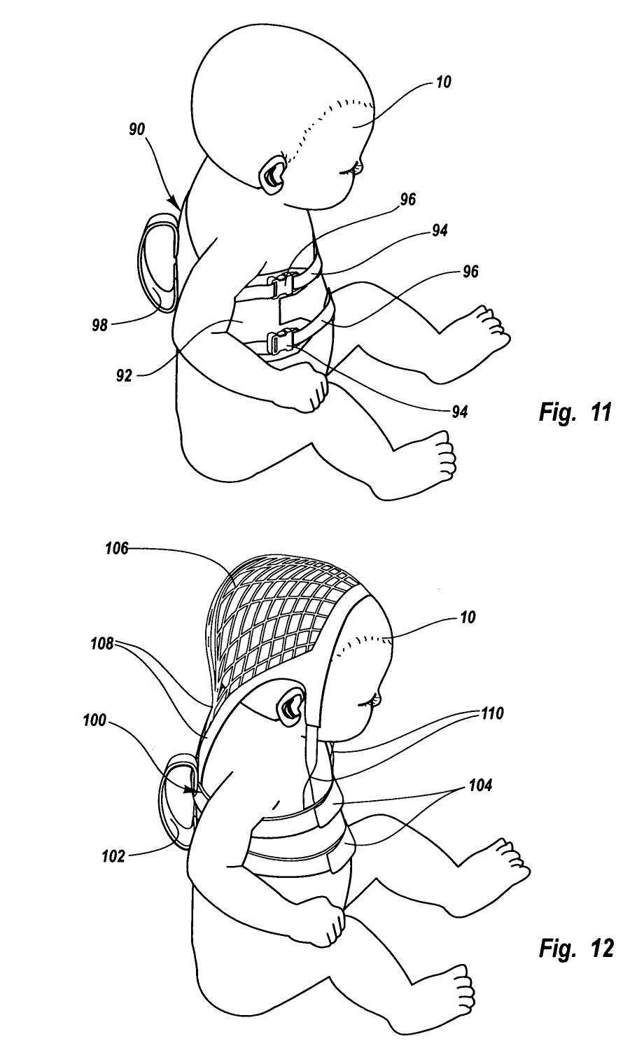

FIG. 11 depicts an exemplary restraint device 90 that includes a sheet portion 92 that at least partially wraps around a child's body when in use. A pair of straps 94 extend from one end of sheet portion 92 and attach to fastening devices 96 located at an opposite end of sheet portion 92. A handle 98 is attached to sheet portion 92 in a manner so as to be substantially aligned with or parallel to the child's spine. It will be appreciated that restraint device 90 can be repositioned so that handle 98 is adjacent to the front of the child's body (e.g., at or near the sternum). Sheet portion 92 and straps 94 comprise a corset or harness used to releasably attach handle 98 to a child's body. Fastening devices 96 may comprise any known fastening device that allows restraint device 90 to be releasably attached to a child's body.

FIG. 12 depicts an exemplary restraint device 100 that includes a handle 102 attached to a child 10 by means of a pair of straps 104 comprising a corset or harness, and a head restraining system for maintaining the child's head in a desired orientation or position relative to the child's body. This embodiment is particularly useful for a young child or infant whose neck muscles are too weak to adequately support its head. The head restraining system comprises a hood 106 attached to one side of restraint device 100 by means of first hood straps 108 and to another side of restraint device 100 by second hood straps 110. Hood straps 108, 110 are sized and configured so as to work together to maintain the hood 106 in a desired orientation relative to corset or harness 104 of restraint device 100. In this way, hood 106 can hold the head of a child 10 in a desired position relative to its body when in a standing, sitting or reclining position. Some or all of hood straps 108, 110 (or other feature used to attach a hood to a restraint device) may be releasably attached to the corset or harness portion.

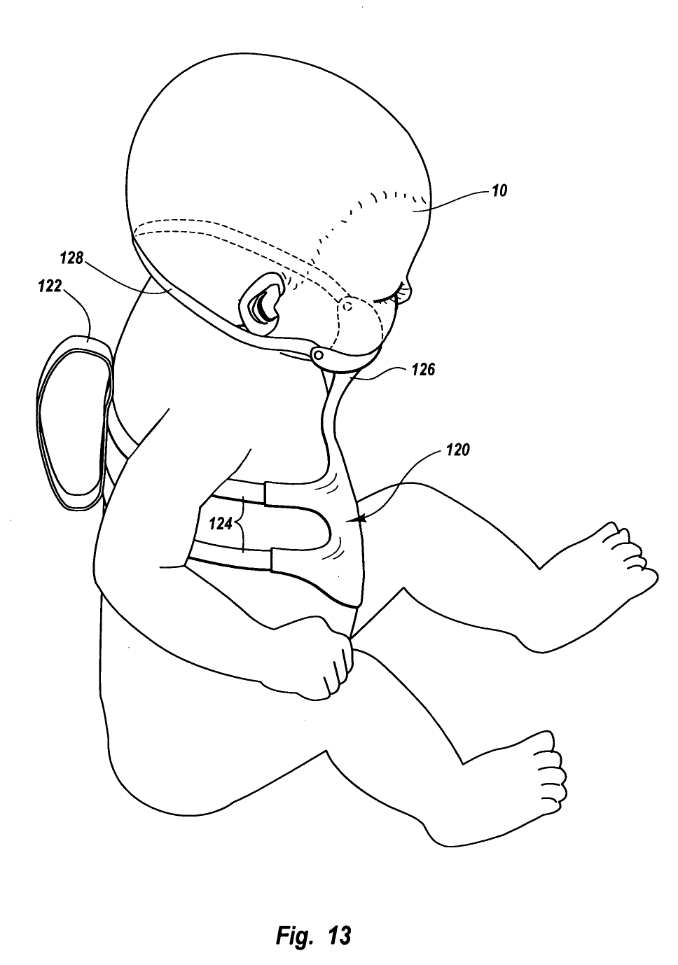

FIG. 13 depicts an exemplary restraint device 120 that includes a handle 122 attached to a child 10 by means of a corset or harness 124. Attached to or part of corset or harness 124 is a chin brace 126 that engages a chin or underside of the child's head. Chin brace 126 advantageously keeps the head from falling or tilting too far forward relative to the child's body. Chin brace 126 may further include a head strap 128 that is sized and configured so as to wrap around a portion of the child's head in order to keep the head from falling or tilting too far backward relative to chin brace 126. In this way, chin brace 126 and head strap 128 can work together to hold or restrain the child's head in a desired position relative to restraint device 120. This, in turn, maintains the child's head in a desired position relative to the child's body when in a sitting, standing or reclining position.

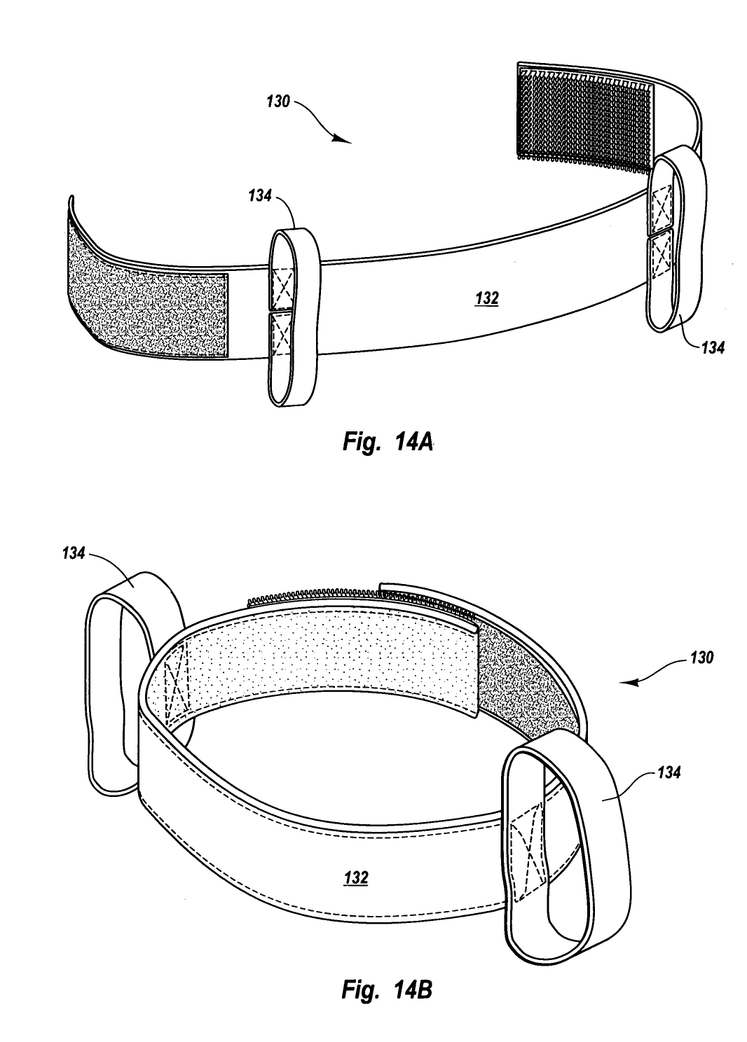

FIGS. 14A and 14B depict an exemplary restraint device 130 that includes a strap or sheet 132 sized and configured so as to wrap at least partially around a child's body. A pair of handles 134 are attached to the strap or sheet 132 and spaced apart so that, when the strap or sheet 132 is wrapped around a child's body, handles 134 are generally on opposite sides of the child's body. Handles 134 of restraint device 130 are advantageously positioned so as to not impede the ability to overlap opposing ends of strap or sheet 132 when attaching it to a child's body.

In one exemplary method of using restraint device 130, opposing handles 134 may be positioned adjacent to the child's chest and back, respectively. In an alternative method of using restraint device 130, opposing handles 134 may be positioned adjacent to the child's left and right sides, respectively (e.g., under the arm pits). In either position, handles 134 are located closer to the child's center of gravity than the child's arms or legs such that gripping handles 134 provides far greater balance and stability when lifting, steadying, or otherwise holding the child in a desired position.

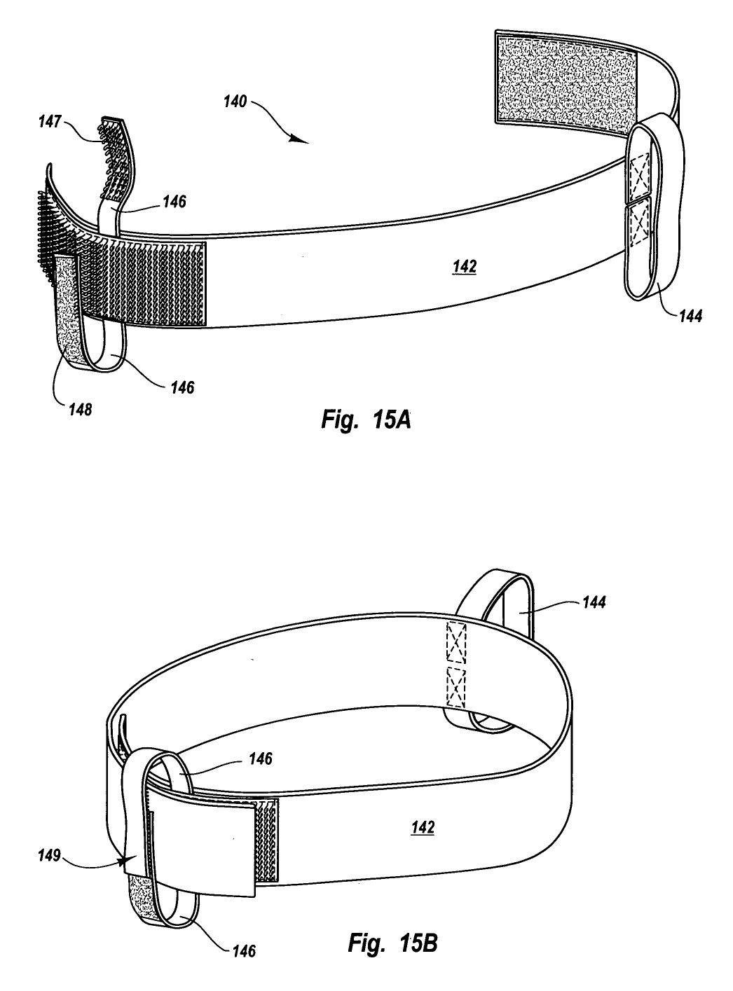

FIGS. 15A and 15B depict an exemplary restraint device 140 that includes a strap or sheet 142 sized and configured so as to wrap at least partially around a child's body. A handle 144 is attached approximately midway between opposite ends of strap or sheet 142. A pair of cooperating straps 146 are attached near an end of strap or sheet 142 and include a region of hooks 147 on one of the cooperating straps 146 and a region of corresponding loops 148 on another of straps 146. In this way, cooperating straps 146 can be selectively attached and detached as desired, such as to form an auxiliary handle 149 if desired (FIG. 15B). Opposing straps 146 may be positioned so that, when strap or sheet 142 is wrapped around a child's body, handle 144 and auxiliary handle 149 are located on opposite sides of restraint device 140. In this way grasping handles 144 and 149 to lift or hold a child results in the child being held in a more balanced and comfortable manner compared to grasping the child's arms or body.

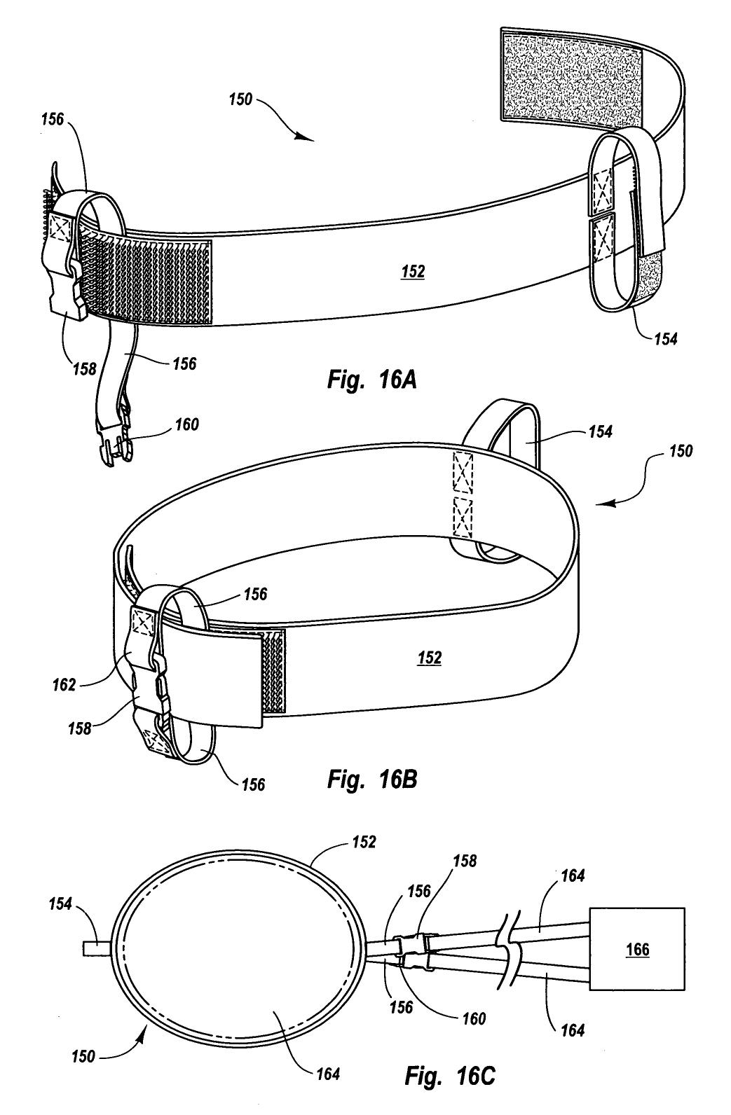

FIGS. 16A-16C depict an exemplary restraint device 150 that includes a strap or sheet 152 sized and configured so as to wrap at least partially around a child's body. A handle 154 is attached approximately midway between opposite ends of strap or sheet 152. A pair of cooperating straps 156 are attached near an end of strap or sheet 152 and include a female clasp 158 attached to an end of one cooperating strap 156 and a male clasp 160 attached to an end of another cooperating strap 156. In this way cooperating straps 156 can be selectively attached and detached as desired, such as to form an auxiliary handle 162 if desired (FIG. 16B).

FIG. 16C illustrates an alternative use of restraint device 150 in which cooperating straps 156 are attached to an auxiliary device 166 by means of a leash or other strap device 164. Auxiliary device 166 schematically depicts any conceivable device, object, structure, person, etc.

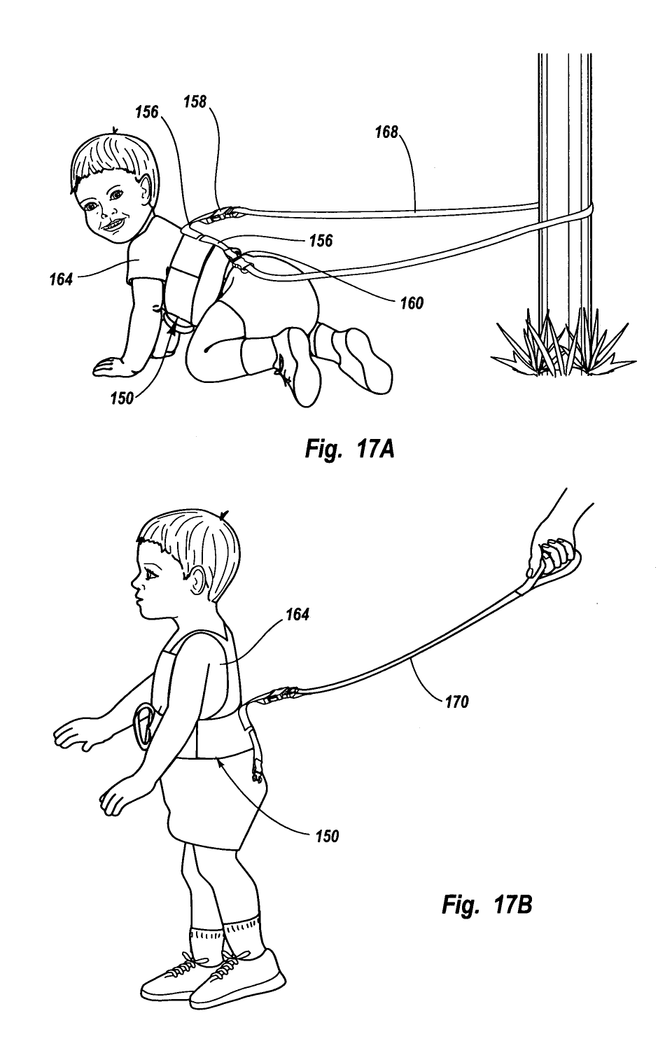

As illustrated in FIG. 17A, a restraint device (e.g., restraint device 150) can be used to attach a child 164 to a stationary object by means of a leash or strap 168. Alternatively, as illustrated in FIG. 17B, a restraint device (e.g., restraint device 150) can be used to attach a child 164 to a leash 170 configured to be gripped by a person.

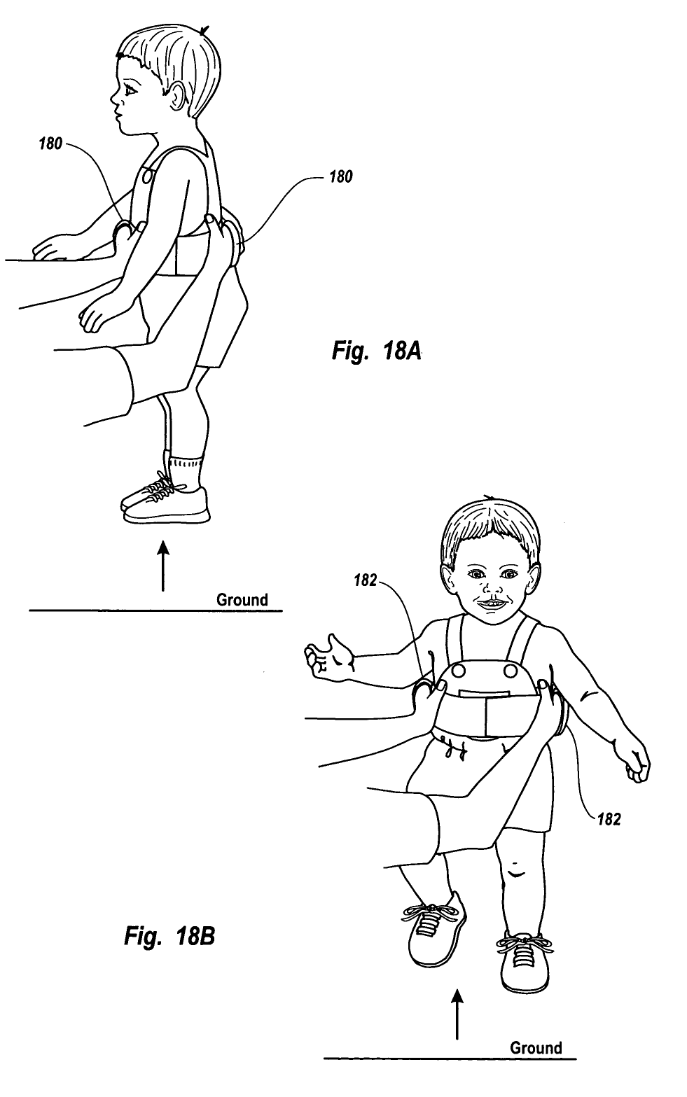

FIG. 18A demonstrates that a pair of opposing handles 180 attached adjacent to the chest and back of a child, respectively, can be used to easily grasp a child in order to, e.g., lift, restrain or otherwise maintain the child in a desired position or location compared to simply grabbing arms, legs or other part of a child's body.

FIG. 18B demonstrates that a pair of opposing handles 182 attached adjacent to left and right sides a child's body, respectively, can be used to easily grasp a child in order to, e.g., lift, restrain or otherwise maintain the child in a desired position or location compared to simply grabbing arms, legs or other part of a child's body.

The various components comprising the restraint devices according to the invention may comprise any desired material that is able to provide a desired level of flexibility, stiffness, comfort or other desired performance criteria and features. For example, the corset or harness, including any straps, sheets or other part intended to wrap around a child's body, may comprise at least one of a fabric, plastic, elastomer, metal or composite material. The corset or harness may be solid or it may comprise a mesh, fabric or other porous structure. A porous structure may be advantage where it is desired for water to flow through the restraint device (e.g., to wet and wash a child's skin). The handle may comprise one or more of a fabric, plastic, elastomer, metal, ceramic or composite material to provide a desired level of flexibility, stiffness, friction or other desired property.

Various portions of child restraint devices according to the invention may include two more different kinds of materials sandwiched or otherwise joined together to provide a multiplicity of functionality or properties. For example, a portion of a child restraint device may comprise a relatively strong material having sufficient strength and resistance to prevent unwanted elongation in one layer or portion and a relatively weak or soft material in another layer or portion that provides increased comfort and protection when placed against the child's skin or body parts. For example, a corset or harness wrapped around a child's body may comprise a relatively strong fabric in one layer and a relatively soft layer next to the stronger fabric that is designed to contact the child's body when is in use.

By way of example and not limitation, it may be advantageous for at least a portion of the handle to comprise a fabric that may be easily sewn onto a corset or harness but which encases a strip of metal, plastic or ceramic that provides the handle with increased stiffness or strength. The handle may include an elastomer or other material of increased friction that increases the ability to grip of the handle, particularly when wet with soapy water. Any portion of the restraint device may include holes or passages that permit increased flow of water therethrough.

The child restraint devices according to the invention may be used to hold, restrain or otherwise maintain a child in a desired position for any reason. In one embodiment, a restraint device according to the invention may be used to assist a person in maintaining an infant or young child in a desired position while giving it a bath. The handle provides a more reliable grasp of an infant or young child compared to grasping a child's limb. The handle is advantageously sized and configured so as to be easily and readily gripped by a hand of the parent or other person giving the child a bath.

Where the restraint device includes a single handle, the restraint device may be designed so that the handle is readily positionable on either the front or back of a child. Alternatively, the child restraint device may be configured so that the handle is only suitable for placement next to one of a child's back or front, but not both. It is also within the scope of the invention to provide a restraint device that includes two opposing handles, one for each of the child's front and back (or left or right sides). This embodiment is particularly useful when lifting a child using both hands (e.g., while placing child into, or removing it from, a bathtub).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A restraint device for use in holding or restraining a child in a desired position, comprising:
handle means for gripping the restraint device; and
attachment means for attaching the handle means to a child's body in a manner so that the handle means is positioned at or near a central balancing plane of a child's body.

2. A restraint device as defined in claim 1, the handle means comprising at least one loop, the loop comprising at least one of a fabric, plastic, elastomer, metal, ceramic, or composite material.

3. A restraint device as defined in claim 1, the attachment means comprising a single sheet or strap of a flexible material configured so as to wrap at least partially around a child's body.

4. A restraint device as defined in claim 1, the attachment means comprising a plurality of straps configured so as to wrap at least partially around a child's torso or limbs.

5. A restraint device as defined in claim 1, the attachment means comprising one or more fastening devices configured so as to releasably attach the attachment means to a child's body.

6. A restraint device as defined in claim 5, the fastening devices comprising one or more of a hook and loop system, a buckle, a tie, a snap, a latch, or a ratchet.

7. A restraint device as defined in claim 1, the attachment means configured so as to position the handle means at or near at least one of a child's spine or sternum.

8. A restraint device as defined in claim 1, the attachment means configured so as to position the handle means at or near a center of at least one of a child's chest, upper back, lower back, or stomach.

9. A restraint device as defined in claim 1, further comprising a head restraining system configured to restrain a child's head in a desired position relative to the child's body when the restraint device is in use.

10. A restraint device for use in holding or restraining a child in a desired position, comprising:
a flexible corset or harness sized and configured so as to wrap around at least a portion of a child's body;
at least one fastening device connected to the corset or harness that permits selective fastening and unfastening of the corset or harness around at least a portion of the child's body; and
a handle attached to the corset or harness in a manner so that the handle is positioned at or near a central balancing plane of the child's body when the restraint device is in use.

11. A restraint device as defined in claim 10, the handle comprising a loop.

12. A restraint device as defined in claim 10, the handle having sufficient friction that it can be reliably gripped without significant slippage when contacted with soapy water.

13. A restraint device as defined in claim 10, the corset or harness comprising at least one of a fabric, plastic, elastomer, metal or composite material.

14. A restraint device as defined in claim 10, the corset or harness comprising a flexible sheet or strap.

15. A restraint device as defined in claim 10, the corset or harness comprising a plurality of straps.

16. A restraint device as defined in claim 10, the corset or harness comprising a plurality of flexible straps sized and configured so as to wrap around at least one of a child's torso, shoulders, or legs.

17. A restraint device as defined in claim 10, further comprising a head restraint device configured to restrain a child's head in a desired position relative to the child's body when the restraint device is in use.

18. A restraint device as defined in claim 10, wherein the fastening device comprises at least one of a hook and loop system, a buckle, a tie, a snap, a latch, or a ratchet.

19. A restraint device as defined in claim 10, further comprising a second handle attached to the corset or harness in a manner so that the second handle is positioned at or near a central balancing plane on an opposite side of the child's body relative to the handle when the restraint device is in use.

20. A method of holding or restraining a child in a desired position while giving the child a bath, comprising:
releasably attaching a handle to the child so that the handle is positioned at or near a central balancing plane of the child's body; and
gripping the handle so as to hold or restrain the child in a desired position within a container or basin that holds therein a quantity of water.

21. A method as defined in claim 20, the child being held in at least one of a sitting or standing position during at least a portion of time in which the child is held or restrained within the container or basin.

22. A method as defined in claim 20, wherein the handle is attached adjacent to the child's spine or sternum.

23. A method as defined in claim 20, wherein the handle is attached adjacent to the child's side.

24. A method as defined in claim 20, further comprising releasably attaching a second handle on a side of the child's body opposite the handle so that the second handle is positioned at or near a central balancing plane of the child's body.

25. A method as defined in claim 25, further comprising gripping both handles while lifting the child into or out of the container or basin.

26. A method as defined in claim 20, wherein the container or basin comprises a bath tub.
